(19) United States
(12) Patent Application Publication
(10) Pub. No.: US 2017/0343854 A1
(43) Pub. Date: Nov. 30, 2017

(54) LIQUID CRYSTAL DISPLAY

(71) Applicant: Mitsubishi Electric Corporation, Tokyo (JP)

(72) Inventor: Hitoshi KOYAMA, Tokyo (JP)

(73) Assignee: Mitsubishi Electric Corporation, Tokyo (JP)

(21) Appl. No.: 15/598,517

(22) Filed: May 18, 2017

(30) Foreign Application Priority Data
May 25, 2016 (JP) 2016-103941

(51) Int. Cl. G02F 1/1335; G02F 1/1333; G06F 3/044

(52) U.S. Cl. CPC G02F 1/133528; G06F 3/044; G02F 1/13338; G02F 2201/503; G06F 2203/04103

(57) ABSTRACT

Provided is a liquid crystal display that can prevent occurrence of a scratch on a front surface of a polarizer and display a satisfactory image in performing a touch operation accompanied by frequent gesture operations of rubbing the front surface of the polarizer. The liquid crystal display includes: a display element including an in-cell or on-cell projected capacitive touch panel sensor and a polarizer disposed on a display surface of the display element; and a protective layer disposed on the polarizer. The protective layer has a pencil hardness higher than or equal to 4H.

### BACKGROUND OF THE INVENTION

### Field of the Invention

The present invention relates to a liquid crystal display, and particularly to a measure against a scratch on a front surface of a polarizer included in a liquid crystal display involving in-cell or on-cell projected capacitive touch panel (hereinafter referred to as “PCAP”) technology.

### Description of the Background Art

With the recent widespread proliferation of information electronic equipment, thin and light displays have been used as displays for mobile phones and PCs, displays for various industrial devices, vehicle-mounted displays, displays for handy terminals, and advertisement displays. Many of the displays include, as a display element, a transmissive liquid crystal display panel including color filters of red, green, and blue (RGB) for each pixel. The displays display an image by illuminating the display element using a backlight placed at the back surface of the display element, controlling transmission of an electric signal to a liquid crystal according to an input signal, and adjusting an amount of transmitted light in each of the pixels.

In recent years, the PCAPs which have begun to be incorporated into smartphones and tablet terminals have immediately penetrated general displays. With the intensifying price competition as a backdrop and with the aim of reducing the manufacturing costs, methods of incorporating PCAP functions into displays, that is, the in-cell or on-cell PCAPs are being under technical development, following the development of methods of mounting PCAP units in front of conventional displays.

Since a touch sensor layer is formed in a first substrate of the in-cell or on-cell PCAPs, conventional cover glasses and touch sensor substrates become unnecessary, thus enabling reduction in the manufacturing costs. However, since the front surface of a first polarizer placed on the display surface side of the first substrate is frequently touched, it is easily scratched and causes significant reduction in the visual quality of the display.

As one measure to solve this problem, a protective layer is formed on the front surface of the first polarizer. Examples of materials of the protective layer include triacetyl cellulose disclosed by Japanese Patent Application Laid-Open No. 2000-276301, an acrylic resin and a silicone resin disclosed by Japanese Patent Application Laid-Open No. 2000-105669, an acrylic resin disclosed by Japanese Patent Application Laid-Open No. 2000-207128, and polysiloxane, polyester, acrylic, and a polyurethane resin disclosed by Japanese Patent Application Laid-Open No. 2003-114766.

Under the techniques disclosed by the four patent applications above, each protective layer is made of a resin, and has a pencil hardness approximately ranging from 2H to 3H. Furthermore, since the techniques above are based on not the PCAPs but resistive film type touch panels, the main touch operation of the resistive film type touch panels is pressing at one point. Here, the pencil hardness of the protective layer which approximately ranges from 2H to 3H may prevent a scratch on the front surface of a polarizer.

The PCAPs are touched at significantly higher frequency than that of the resistive film type touch panels, and are subjected to frequent gesture operations of rubbing the front surface of the polarizer such as zooming in and out and flicking as one type of touch operations. In consideration of these, the pencil hardness of the protective layer which approximately ranges from 2H to 3H is insufficient in strength.

### SUMMARY

An object of the present invention is to provide a liquid crystal display that can prevent occurrence of a scratch on a front surface of a polarizer and display a satisfactory image in performing a touch operation accompanied by the frequent gesture operations of rubbing the front surface of the polarizer.

The liquid crystal display includes: a display element including an in-cell or on-cell projected capacitive touch panel sensor and a polarizer disposed on a display surface of the display element; and a protective layer disposed on the polarizer. The protective layer has a pencil hardness higher than or equal to 4H.

Since the pencil hardness of the protective layer is higher than or equal to 4H, the occurrence of a scratch on the front surface of the polarizer can be prevented even in performing the touch operation accompanied by the frequent gesture operations of rubbing the front surface of the polarizer. Accordingly, the liquid crystal display can display a satisfactory image.

### BRIEF DESCRIPTION OF THE DRAWINGS

FIG. 1 is an exploded perspective view of a liquid crystal display according to an embodiment;

FIG. 2 illustrates a cross section taken along the line A-A of FIG. 1;

FIG. 3 illustrates an enlarged view of an area B of FIG. 2 when a protective layer is not provided;

FIG. 4 illustrates an enlarged view of the area B of FIG. 2 when a protective layer whose pencil hardness ranges from 4H to 7H is provided;

FIG. 5 illustrates an exploded perspective view of a liquid crystal display according to a premise technique;

FIG. 6 illustrates a cross section taken along the line C-C of FIG. 5; and

FIG. 7 illustrates an enlarged view of an area D of FIG. 6.

### DESCRIPTION OF THE PREFERRED EMBODIMENTS

[Premise Technique]

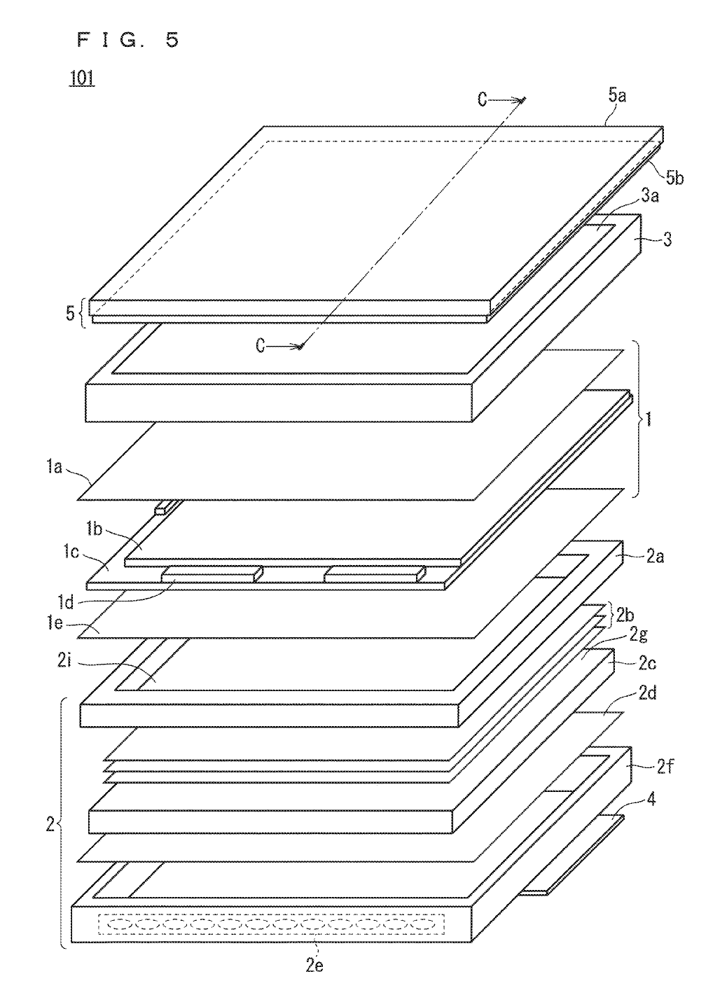

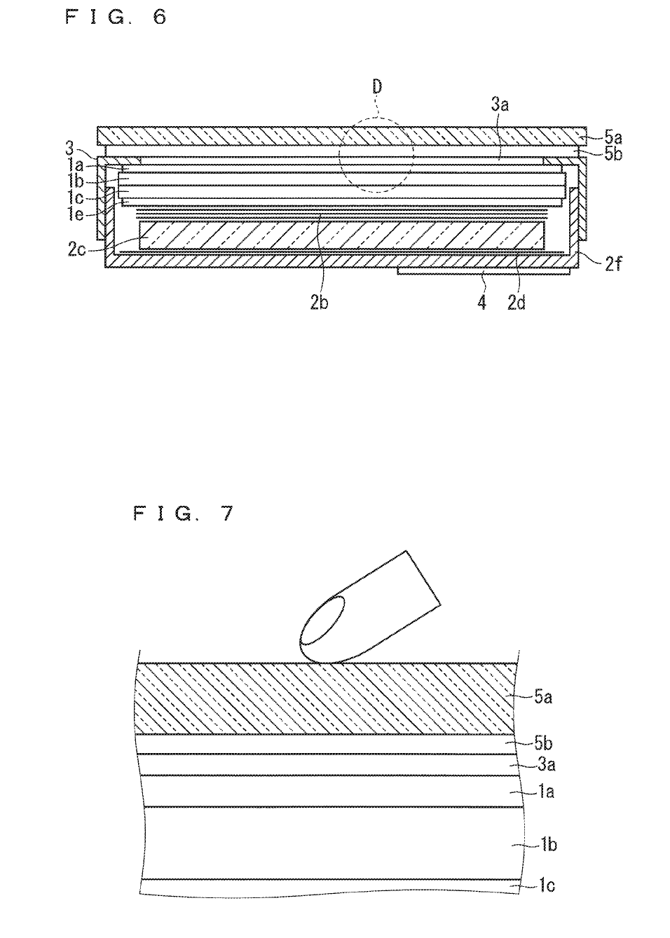

Before starting an embodiment of the present invention, the premise technique will be described. FIG. 5 illustrates an exploded perspective view of a liquid crystal display 101 according to the premise technique. FIG. 6 illustrates a cross section taken along the line C-C of FIG. 5. FIG. 7 illustrates an enlarged view of an area D of FIG. 6.

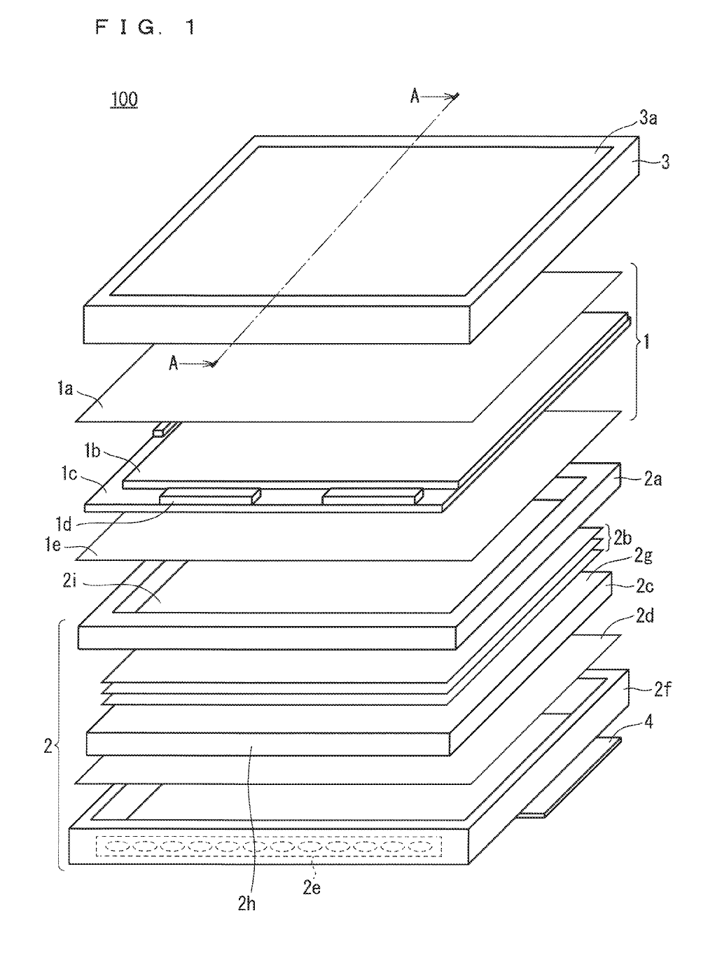

As illustrated in FIGS. 5 and 6, the liquid crystal display 101 is a projected capacitive liquid crystal display of a resistive film type. The liquid crystal display 101 includes a display element 1, a backlight 2, a front frame 3, a circuit board 4, and a touch panel 5. The backlight 2 illuminates the display element 1 from a surface opposite to a display surface of the display element 1. The front frame 3 includes an opening 3a, and houses the display element 1 and the backlight 2. The circuit board 4 controls a transmittance of each pixel of the display element 1 according to an image input signal. Here, the display surface side is an upper portion in FIG. 5, and the surface side opposite to the display surface side is a lower portion in FIG. 5. The same holds true for FIG. 1.

The touch panel 5 is placed on a front surface side of the display element 1, that is, the display surface side, and receives a position signal on a screen from outside the touch panel 5. The touch panel 5 includes a touch sensor substrate 5b, and a transparent protective plate 5a that protects the touch sensor substrate 5b. Furthermore, a cover (not illustrated) for protecting the circuit board 4 may be placed at the back surface side of the circuit board 4, that is, the surface side opposite to the display surface.

Next, each of the parts included in the liquid crystal display 101 will be described. The touch panel 5 converts, with a circuit including a transparent electrode formed on a transparent substrate, information on position coordinates that is input from outside or by a user into an electric signal and transmits the electric signal to a control circuit of a final product through an output wiring part connected to the end of the touch panel 5. Although a flexible printed circuit (FPC) obtained by forming wires on a film substrate is used as the output wiring part in consideration of freedom of connection depending on thinness and flexibility, the output wiring part may be made of a different material or have a different structure from that of the FPC as long as it has the same functions and characteristics as those of the FPC.

As illustrated in FIGS. 5 to 7, the protective plate 5a formed of a transparent material such as glass or plastic is placed on a front surface side of the touch sensor substrate 5b to prevent, for example, damage, deformation, wear and tear, and smudges caused by pressure or contact from an input surface side with respect to the display element 1 and the touch sensor substrate 5b. The front surface or surroundings of the back surface of the protective plate 5a may be printed to shield light or for a design purpose.

### Embodiment

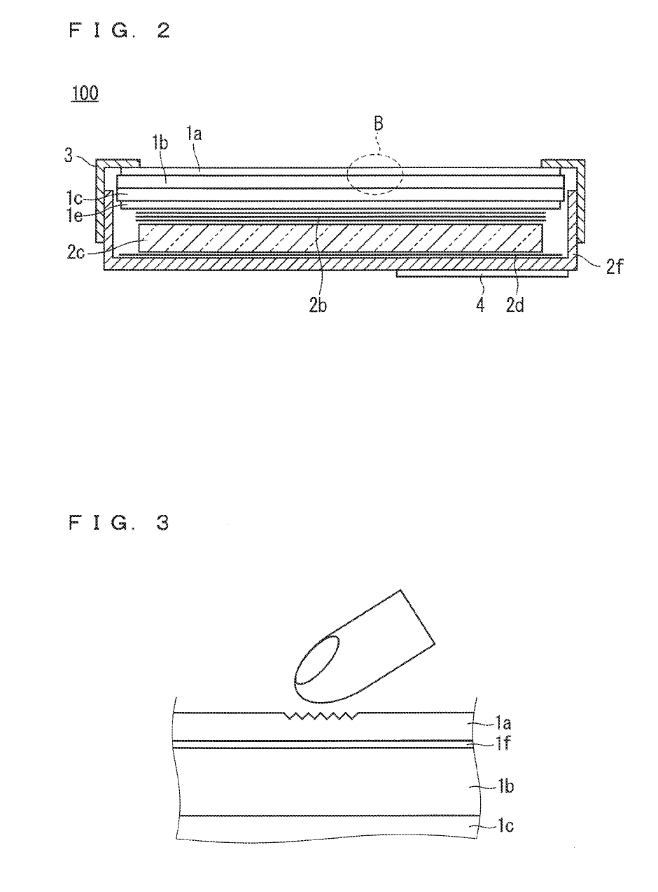

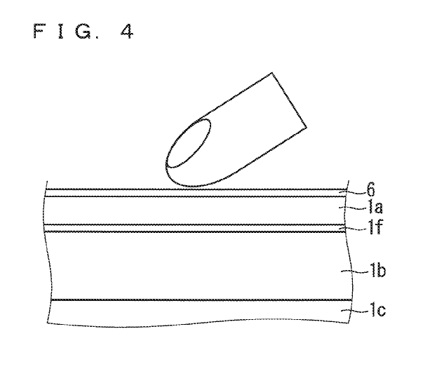

Next, an embodiment of the present invention will be described with reference to the drawings. FIG. 1 is an exploded perspective view of a liquid crystal display 100 according to the embodiment. FIG. 2 illustrates a cross section taken along the line A-A of FIG. 1. FIG. 3 illustrates an enlarged view of an area B of FIG. 2 when a protective layer 6 is not provided. FIG. 4 illustrates an enlarged view of the area B of FIG. 2 when the protective layer 6 whose pencil hardness ranges from 4H to 7H is provided. The same reference numerals will be assigned to the same constituent elements as those described for the premise technique, and the description thereof will be omitted.

As illustrated in FIGS. 1 and 2, the liquid crystal display 100 is an in-cell or on-cell projected capacitive liquid crystal display. The liquid crystal display 100 includes the display element 1, the backlight 2, the front frame 3, and the circuit board 4.

[Display Element]

The display element 1 is a transmissive or semi-transmissive liquid crystal display panel. The display element 1 applies birefringence of a liquid crystal, and includes (i) a first substrate 1b obtained by forming, for example, a color filter, a light shield layer, and a counter electrode on an insulating substrate made of glass, etc., and (ii) a second substrate 1c obtained by forming, for example, a pixel electrode and a thin film transistor (hereinafter referred to as “TFT”) functioning as a switching element on an insulating substrate made of glass, etc. The second substrate 1c is disposed opposite to the display surface of the display element 1 with respect to the first substrate 1b.

The display element 1 further includes a spacer for maintaining the spacing between the first substrate 1b and the second substrate 1c, a sealant for sealing the first substrate 1b to the second substrate 1c, a liquid crystal sandwiched between the first substrate 1b and the second substrate 1c, a sealing material for sealing an injection hole for injecting the liquid crystal, an alignment layer for orienting the liquid crystal, a first polarizer 1a disposed on the display surface of the display element 1 which corresponds to a polarizer, a second polarizer 1e disposed opposite to the display surface with respect to the second substrate 1c, and driving integrated circuits (ICs) 1d arranged at an outer region of the second substrate 1c or arranged on a tape-shaped wiring material connected to the outer region of the second substrate 1c. Examples of the tape-shaped wiring material include a tape carrier package (TCP) and a chip on film (COF).

An in-cell or on-cell projected capacitive touch panel sensor 1f is formed on the first substrate 1b. The touch panel sensor 1f senses a touch operation. Specifically, the latticed touch panel sensor if is formed on the back surface side of the first substrate 1b when being an in-cell projected capacitive touch panel sensor, and is formed on the front surface side of the first substrate 1b when being an on-cell projected capacitive touch panel sensor. In FIGS. 3 and 4, the touch panel sensor if is formed on the front surface side of the first substrate 1b, thus illustrating the on-cell projected capacitive touch panel sensor.

Since the protective plate 5a and the touch sensor substrate 5b described in the “Premise technique” are unnecessary in both the in-cell and on-cell projected capacitive touch panel sensors, the front surface of the first polarizer 1a is frequently rubbed in a touch operation when the protective layer 6 is not provided as illustrated in FIG. 3. As illustrated in FIG. 4, the protective layer 6 is formed on the front surface of the first polarizer 1a to prevent occurrence of a scratch on the front surface of the first polarizer 1a even in performing the touch operation accompanied by frequent gesture operations of rubbing the front surface of the first polarizer 1a. The details of the protective layer 6 will be described later.

[Backlight]

The backlight 2 includes a light source 2e that emits light, a light guide plate 2c that propagates the light emitted from the light source 2e, optical sheets 2b arranged on an emission surface 2g side of the light guide plate 2c to control distribution and spread of the light emitted from the light guide plate 2c, a light reflection sheet 2d that directs the light escaping through a non-emission surface (not illustrated) of the light guide plate 2c toward the light guide plate 2c, an inner frame 2a, and a rear frame 2f. The inner frame 2a and the rear frame 2f hold the light source 2e, the light guide plate 2c, the optical sheets 2b, and the light reflection sheet 2d. The backlight 2 illuminates the display element 1 from the second substrate 1c side that is opposite to the display surface of the display element 1.

The light guide plate 2c is formed of, for example, a transparent acrylic resin, a polycarbonate resin, or glass. The non-emission surface (not illustrated) or the emission surface 2g side of the light guide plate 2c has a light scattering dot pattern or a prism shape to emit light and adjust intensity distribution and an emission direction of light in a plane thereof.

The optical sheets 2b are arranged closer to the emission surface 2g side of the light guide plate 2c to adjust the intensity distribution and an emission angle of emitted light Lens sheets for collecting light, diffusion sheets for homogenizing light, or viewing-angle adjustment sheets for adjusting brightness in a viewing-angle direction are arranged as the optical sheets 2b as many as necessary, depending on the purpose.

Although an edge-lit backlight including the light source 2e disposed on the side surface 2h of the light guide plate 2c is described in the embodiment, a beneath-lit backlight excluding the light guide plate 2c and including a light source disposed on the entire bottom of the back case 2f opposing the back surface of the display element 1 can produce the same advantages as those of the edge-lit backlight.

The inner frame 2a has an opening 2i for allowing the emission surface 2g of the light guide plate 2c to emit light, and holds the display element 1 that is positioned thereon. The inner frame 2a can be made of a metal such as aluminum, stainless steel, or iron, or a resin such as polycarbonate (PC) or acrylonitrile butadiene styrene (ABS).

[Front Frame]

The front frame 3 is a frame part that holds, for example, the display element 1 and the backlight 2. The front frame 3 is produced from, for example, a thin metal plate or a resin molded product, and is fixed to the backlight 2, for example, using a chain stretch or through screwing. The front frame 3 may be formed as a single part, or by combination of parts. Furthermore, attachment parts for attachment to a final product may be provided on the side surface, the front surface, or the back surface of the front frame 3, or around these surfaces. Examples of the attachment parts include a screw and an attaching hole.

[Circuit Board]

A control circuit (not illustrated) is mounted on the circuit board 4, and controls the display element 1 and the light source 2e according to electric input and output signals. The circuit board 4 normally has a copper pattern on a substrate made of, for example, glass epoxy, and electrical parts are soldered to the surface of the circuit board 4. Although the circuit board 4 is mainly fixed to the back surface of the liquid crystal display 100, that is, a side from which no light is emitted, the control circuit may be formed by mounting electrical parts on an FPC obtained by forming wires on a film substrate connected to the display element 1 without the circuit board 4.

Furthermore, the circuit board 4 may be equipped with a protection cover (not illustrated) made of a metal such as aluminum, stainless steel, or galvanized sheet iron, or a thin film resin such as polyethylene terephthalate (PET) to protect the circuit board 4 from outside pressure or electrostatic damage. When the circuit board 4 is equipped with the protection cover made of a metal, it is preferred to insulate the protection cover by sticking a resin sheet made of, for example, PET to the circuit board 4 side to prevent electrical contact with the circuit board 4 and the electrical parts on the circuit board 4.

Next, a structure and advantages for enabling the liquid crystal display 100 according to the embodiment to prevent occurrence of a scratch on the front surface of the first polarizer 1a and display a satisfactory image will be described.

As illustrated in FIG. 4, the protective layer 6 is formed on the front surface of the first polarizer 1a. The protective layer 6 is a glass layer or an inorganic layer formed of an inorganic material such as SiN, SiO₂, or TiO₂. The protective layer 6 is formed with a pencil hardness higher than or equal to 4H or preferably higher than or equal to 6H. Specifically, the protective layer 6 is formed with a pencil hardness ranging from 4H to 7H.

In an initial trial of this embodiment, a SiN film was formed on the front surface of the first polarizer 1a as the protective layer 6 using a plasma CVD method. However, the front surface of the first polarizer 1a was damaged if a deposition temperature was not controlled approximately at 150° C. The properties of the SiN film became brittle when the deposition temperature was around 150° C. As a consequence of additional trials under the other film forming conditions, none of the films achieved sufficient hardness.

In another trial, the SiN film was then formed on the front surface of the first polarizer 1a by sputtering. This method also faced the same problems with damage on the front surface of the first polarizer 1a and brittleness in the properties of the SiN film as seen in the plasma CVD method. However, optimizing mainly the deposition temperature and the deposition rate enabled the SiN film to be formed with the pencil hardness ranging from 4H to 7H without damaging the front surface of the first polarizer 1a. The hardness of the SiN film and mainly the deposition rate are in a trade-off relationship. Thus, the optimal pencil hardness value was selected in view of the pencil hardness value and the manufacturing cost that were required of the final product.

Since the pencil hardness value of the protective layer 6 in the liquid crystal display 100 according to the embodiment is higher than or equal to 4H, occurrence of a scratch on the front surface of the first polarizer 1a can be prevented even in performing the touch operation accompanied by frequent gesture operations of rubbing the front surface of the first polarizer 1a. Accordingly, the liquid crystal display 100 can display a satisfactory image.

Specifically, since the protective layer 6 has the pencil hardness ranging from 4H to 7H, the prevention of occurrence of a scratch on the front surface of the first polarizer 1a is compatible with reduction in the manufacturing cost of the liquid crystal display 100.

Next, a modification of the embodiment will be described. In another trial, a SiO₂ film or a TiO₂ film was formed on the front surface of the first polarizer 1a by sputtering similarly as in the former case. Optimizing mainly the deposition temperature and the deposition rate enabled the SiO₂ film or the TiO₂ film that is made of the inorganic material to be formed with the pencil hardness ranging from 4H to 7H without damaging the front surface of the first polarizer 1a. The hardness of the SiO₂ film or the TiO₂ film and mainly the deposition rate are in a trade-off relationship. Thus, the optimal pencil hardness value was selected in view of the pencil hardness value and the manufacturing cost that were required of the final product.

Accordingly, the protective layer 6 is, for example, formed of an inorganic material such as SiN, SiO₂, or TiO₂. Using such commercially available materials can reduce the manufacturing cost of the liquid crystal display 100.

Furthermore, a TiO₂ film with a refractive index ranging from 1.8 to 2.5 as a first inorganic material and a SiN film or a SiO₂ film with a refractive index ranging from 1.3 to 1.7 as a second inorganic material may be alternately laminated on the front surface of the first polarizer 1a by sputtering similarly as in the former cases. Also in this case, optimizing mainly the deposition temperature and the deposition rate enabled a film to be formed with the pencil hardness ranging from 4H to 7H without damaging the front surface of the first polarizer 1a. It was revealed through measurements in the liquid crystal display 100 that the reflectivity of the front surface of the first polarizer 1a having such alternate lamination of the TiO₂ film and the SiN film or the SiO₂ film was reduced to less than 1% compared to the normal first polarizer 1a having no alternate lamination.

As described above, the protective layer 6 is formed by alternately laminating the first inorganic material with a refractive index ranging from 1.8 to 2.5 and the second inorganic material with a refractive index ranging from 1.3 to 1.7, and the first inorganic material includes TiO₂, and the second inorganic material includes SiN or SiO₂. Accordingly, the reflectivity of the front surface of the first polarizer 1a having the alternate lamination of the TiO₂ film and the SiN film or the SiO₂ film can be significantly reduced more than that of the normal first polarizer 1a having no alternate lamination.

Furthermore, a thin glass sheet with a thickness of 0.2 mm (corresponding to a glass layer) may be sticked to the front surface of the first polarizer 1a as the protective layer 6. The glass layer functioning as the protective layer 6 has a pencil hardness ranging from 8H to 10H. Specifically, the glass layer has a pencil hardness of 9H. The thickness of the glass layer functioning as the protective layer 6 does not have to be strictly 0.2 mm, but may be less than 0.2 mm as long as the pencil hardness of the glass layer ranges from 8H to 10H.

Since the protective layer 6 is a glass layer with a thickness of 0.2 mm, it can prevent occurrence of a scratch on the front surface of the first polarizer 1a even in performing the touch operation accompanied by frequent gesture operations of rubbing the front surface of the first polarizer 1a. Accordingly, the liquid crystal display 100 can display a satisfactory image.

Since the pencil hardness of the glass layer functioning as the protective layer 6 ranges from 8H to 10H, the prevention of occurrence of a scratch on the front surface of the first polarizer 1a is compatible with reduction in the manufacturing cost of the liquid crystal display 100.

The embodiment of the present invention can be appropriately modified or omitted within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display, comprising:
a display element including an in-cell or on-cell projected capacitive touch panel sensor and a polarizer disposed on a display surface of said display element; and
a protective layer disposed on said polarizer,
wherein said protective layer has a pencil hardness higher than or equal to 4H.

2. The liquid crystal display according to claim 1,
wherein said protective layer has a pencil hardness ranging from 4H to 7H.

3. The liquid crystal display according to claim 1,
wherein said protective layer includes an inorganic material.

4. The liquid crystal display according to claim 1,
wherein said protective layer is formed by alternately laminating a first inorganic material with a refractive index ranging from 1.8 to 2.5 and a second inorganic material with a refractive index ranging from 1.3 to 1.7.

5. The liquid crystal display according to claim 4,
wherein said first inorganic material includes TiO₂, and said second inorganic material includes SiN or SiO₂.

6. A liquid crystal display, comprising:
a display element including an in-cell or on-cell projected capacitive touch panel sensor and a polarizer disposed on a display surface of said display element; and
a protective layer disposed on said polarizer,
wherein said protective layer includes a glass layer with a thickness of 0.2 mm.

7. The liquid crystal display according to claim 6,
wherein said glass layer has a pencil hardness ranging from 8H to 10H.
